(19) United States
(12) Patent Application Publication
(10) Pub. No.: US 2025/0341437 A1
(43) Pub. Date: Nov. 6, 2025

(54) PRESSURE MONITORING SYSTEM

(71) Applicant: Tyco Fire & Security GmbH, Neuhausen am Rheinfall (CH)

(72) Inventors: JONATHAN DAVID DOUGLAS, Mequon, WI (US); BERNARD P. CLEMENT, Mequon, WI (US); TYLER A. SMITH, Nolensville, TN (US)

(73) Assignee: Tyco Fire & Security GmbH, Neuhausen am Rheinfall (CH)

(21) Appl. No.: 19/198,909

(22) Filed: May 5, 2025

Related U.S. Application Data
(60) Provisional application No. 63/642,952, filed on May 6, 2024.

(51) Int. Cl. G01L 13/06; G01D 7/00; G01D 21/02; G01L 19/00

(52) U.S. Cl. CPC G01L 13/06; G01D 7/005; G01D 21/02; G01L 2019/0053

(57) ABSTRACT

A pressure monitoring system is disclosed. The pressure monitoring system includes a battery powered sensing unit mounted on a partition between a first space and a second space. The sensing unit senses differential pressure between the first space and the second space separated by the door, determines position of the door, and wirelessly communicate differential pressure and door position to a building management system.

### CROSS REFERENCE TO RELATED PATENT APPLICATIONS

This application claims the benefit of and priority to U.S. Provisional Patent Application No. 63/642,952, filed May 6, 2024, the entire disclosure of which is incorporated by reference herein.

### BACKGROUND

The present disclosure relates to pressure monitoring systems.

Differential pressure sensors measure differences in pressure between two reference points. The differential pressure sensors are employed at various locations, for example, in hospitals, to measure differential pressure between patient's room and a corridor proximal to the patient's room.

### SUMMARY

A summary of certain embodiments disclosed herein is set forth below. It should be noted that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure discloses a battery powered sensing unit mounted on a partition between a first space and a second space. The sensing unit senses differential pressure between the first space and the second space, determines position of a door between the first space and the second space, and wirelessly communicates differential pressure and door position to a building management system.

In some embodiments, the sensing unit further includes an illuminator providing visual indication of differential pressure status.

In some embodiments, the illuminator is mounted on a first surface of the door facing the first space. The sensing unit includes a light guide extending between the first surface and an opposite second surface of the door to enable visual indication of the differential pressure status.

In some embodiments, the sensing unit further includes one or more sensors provided to sense at least one of humidity, temperature, and gas concentration associated with the first space.

In some embodiments, the partition is the door between the first space and the second space.

In some embodiments, the partition is a wall between the first space and the second space.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic diagram depicting mounting of a battery operated sensing unit.

FIG. 2a is a schematic block diagram depicting components of the battery operated sensing unit, according to some embodiments.

FIG. 2b is a schematic block diagram depicting components of the battery operated sensing unit, according to some other embodiments.

FIG. 3 is a schematic block diagram depicting communication between the sensing unit and a building management system.

FIG. 4 is a schematic block diagram depicting communication between a plurality of sensing units and the building management system.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

### Pressure Monitoring System

The present disclosure discloses a pressure monitoring system having a battery powered sensing unit. A battery supplies power to components of the sensing unit, thereby eliminating certain wiring needs between the sensing unit and a power source. Further, the sensing unit is configured to determine differential pressure between a first space and a second space, and transmit differential pressure data wirelessly, resulting in a devices which requires no wires to operate.

The sensing unit may be suitably mounted on a partition between the first space and the second space, preferably on a surface of the partition facing the first space. In some embodiments, the first space may be a room, whereas the second space may be a space proximal to the first space, such as a corridor outside the first space. The partition may have a channel that provides an access of air in the second space.

The sensing unit may have a housing for various components of the sensing unit. The housing may be mounted on a surface of the partition that faces the first space. The sensing unit may have a sensing element with a first port and a second port to measure pressure in the first space and the second space, respectively. In some embodiments, the sensing element may be integrated with electronics package provided within the housing. The housing may be ventilated to allow air in the first space to reach the first port. A tube may be connected to the second port. The tube may extend out of the housing, and pass through the channel of the partition so that air in the second space can reach to the second port through the tube.

The sensing unit further includes a door position sensor provided to sense position of a door between the first space and the second space. Door position data is utilized to discard or nullify the differential pressure values when the door is open.

The sensing unit may be suitably mounted on the partition between the first space and the second space. In some embodiments, the partition may be the door between the first space and the second space. The door provides access to the first space. In some other embodiments, the partition may be a wall, for example, a wall proximal to the door.

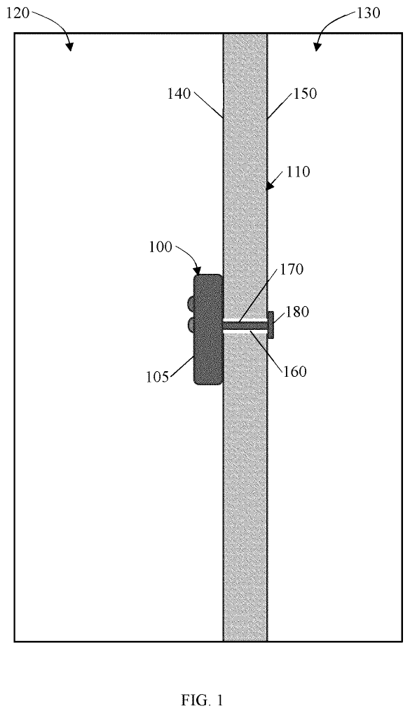

Referring to FIG. 1, an example sensing unit 100 is shown. The sensing unit 100 may include a housing 105 provided to house a plurality of components of the sensing unit 100. The sensing unit 100 may be mounted on a door 110 separating a first space 120 and a second space 130. In some examples, the first space 120 may be a room, and the second space 130 may be proximal to the room, for example, a corridor outside the room. The first space 120 and the second space 130 may share at least one common wall. The door 110 provides access to the first space 120. The door 110 has a first surface 140 and an opposite second surface 150. When the door 110 is closed, the first surface 140 faces the first space 120, and the second surface 150 faces the second space 130. The door 110 further includes a channel 160 extending between the first surface 140 and the second surface 150. The channel 160 may be configured by drilling a hole across the width of the door 110.

In some embodiments, the sensing unit 100 may be implemented in a medical facility, for example, a hospital. In hospitals, certain areas are maintained at higher pressure and certain other areas are maintained at lower pressure than surrounding areas. For example, a clean room is maintained at higher pressure. When a clean room is at higher pressure than surrounding areas, any air leaks result in airflow from the clean room to surrounding areas. This prevents airborne contaminants to enter the clean room. In another example, an operating room (clean room) is to be maintained at a higher pressure than a hallway proximal to the operating room. Dirty procedure rooms (a colonoscopy room) are maintained at lower pressures. Thus, it is required to monitor pressure in various rooms in hospitals to ensure that the pressure relationship is always maintained. When the sensing unit 100 is implemented in a hospital, the first space 120 may be a patient's room, and the second space 130 may be a corridor outside the patient's room. The door 110 is utilized for accessing the patient's room. However, the present disclosure is not limited to implementation of the sensing unit 100 in hospitals only. The sensing unit 100 can be suitably implemented at any other suitable location, including, but not limited to, other medical facilities, research labs, manufacturing facilities, other indoor environments, etc.

As shown in FIG. 1, the housing 105 is mounted on the first surface 140 of the door 110. In some embodiments, the housing 105 may be mounted on the first surface 140 using brackets, fasteners, etc. The sensing unit 100 may further include a light guide. In some embodiments, the channel 160 acts as the light guide. In some other embodiments, a tube 170 of transparent material may be passed through the channel 160 that acts as the light guide. The tube 170 extends from the housing 105 and passes through the channel 160. The tube 170 may extend up to the second surface 150.

The housing 105 may be mounted at a suitable location on the first surface 140. In some embodiments, the housing 105 may be mounted at a substantial middle portion of the first surface 140.

A cover plate 180 may be mounted on the second surface 150 to seal an open end of the channel 160. The cover plate 180 may have a feature to allow light to pass through the cover plate 180. For example, the cover plate 180 may have a hole to allow an observer in the second space 130 to notice light rays coming through the channel 160.

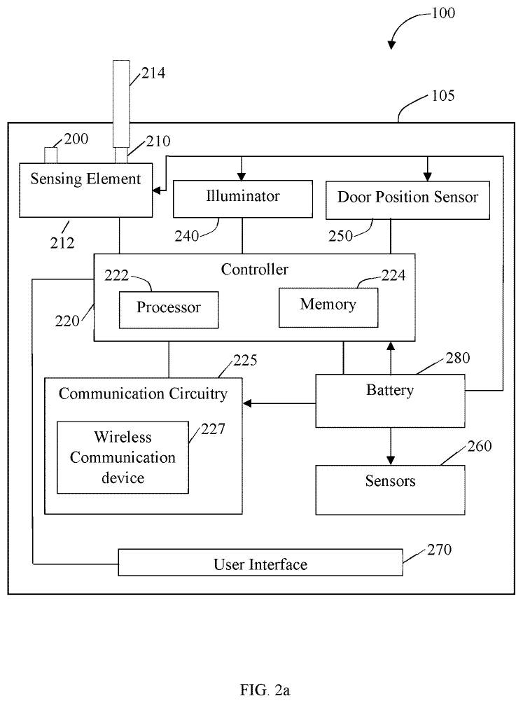

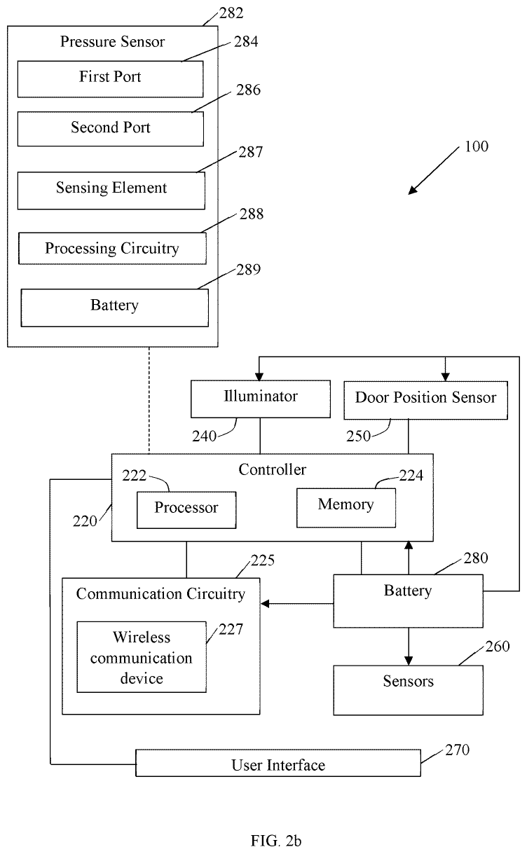

FIG. 2a is a schematic diagram depicting components of the sensing unit 100. The sensing unit 100 is now elaborated in more detail reference to FIG. 1 and FIG. 2a.

The sensing unit 100 includes a pressure sensing element 212 with a first port 200 and a second port 210 to sense pressure in the first space 120 and the second space 130, respectively. The housing 105 may be ventilated to allow air in the first space 120 to reach the first port 200. The second port 210 is connected to a tube 214 that extends out of the housing 105 and passes through the channel 160. The tube 214 establishes fluid communication between the second port 210 and the second space 130 so that air in the second space 130 can reach to the second port 210. The pressure sensing element 212 determines differential pressure value between the first space 120 and the second space 130 based on airflows received via the first port 200 and the second port 210, respectively. In some embodiments, the pressure sensing element 212 may be supplemented with necessary electronics to determine the differential pressure value.

The sensing unit 100 may include a controller 220 disposed in the housing 105, and communicatively coupled to the first port 200 and the second port 210. The controller 220 may include a processor 222 and a memory 224. The processor 222 can be a general purpose or specific purpose processor. The processor 222 may be configured to execute computer code or instructions stored in the memory 224 or received from other computer readable media (e.g., CDROM, network storage, a remote server, etc.).

The memory 224 may include one or more devices (e.g., memory units, memory devices, storage devices, etc.) for storing data and/or computer code for completing and/or facilitating the various processes described in the present disclosure. The memory 224 may include random access memory (RAM), read-only memory (ROM), hard drive storage, temporary storage, non-volatile memory, flash memory, optical memory, or any other suitable memory for storing software objects and/or computer instructions. The memory 224 may include database components, object code components, script components, or any other type of information structure for supporting the various activities and information structures described in the present disclosure. The memory 224 may be communicably connected to the processor 222 and may include computer code for executing (e.g., by the processor) one or more processes described herein.

The pressure sensing element 212 is electrically coupled to the controller 220 to transmit the differential pressure values. In some embodiments, the pressure sensing element 212 is positioned on electronic circuitry of the controller 220. Differential pressure sensor readings are stored locally. The frequency of sampling or storage can be adjustable. In the event of a communication failure local storage can archive the data for communication once communications are restored.

The sensing unit 100 may further include a communication circuitry 225 disposed in the housing 105, and in communication with the controller 220. In some embodiments, the communication circuitry 225 may be a part of the controller 220. In some embodiments, the communication circuitry 225 may communicate with external devices or systems using wireless communication techniques. The communication circuitry 225 may include a wireless communication device 227 to facilitate wireless communication. For example, the communication circuitry 225 may communicate with external server using a LORA WAN radio module, cellular networks, etc. The communication circuitry 225 may use suitable protocol for communication.

In some embodiments, the communication circuitry 225 may utilize any other suitable wireless communication techniques/modules to establish communication with external devices.

The communication circuitry 225 may transmit the differential pressure value to external devices, for example, a remote server, wherein the remote server may be a part of a building management system. The communication circuitry 225 may communicate the latest differential pressure value in predetermined time interval, for example, in every 10 minutes, in every 15 minutes, in every 30 minutes, or in every 1 hour depending upon application requirement. In some embodiments, the controller 220 may receive sensed pressure values and/or determine the differential pressure value in predetermined intervals. The differential pressure values are further transmitted to external devices by the communication circuitry 225.

The sensing unit 100 further includes an illuminator 240 configured to provide visual indication of the differential pressure status. In some embodiments, the illuminator 240 may be one or more LEDs capable of emitting light in different colors for different differential pressure values. For example, the illuminator 240 may emit light in red color if the differential pressure is not within prescribed limit, and emit light in green color if the differential pressure is within prescribed limit. In some embodiments, the prescribed limit may be in accordance with standards/guidelines set by external agencies.

The illuminator 240 may be suitably positioned in the housing 105 such that when the housing 105 is mounted on the door 110, light emitted by the illuminator 240 passes through the channel 160 which can be noticed by an observer in the second space 130. In some embodiments, the illuminator 240 may be mounted outside the housing 105 and on the first surface 140 of the door 110 such that light emitted by the illuminator 240 passes through the channel 160 via the light guide. In some embodiments, the illuminator 240 may be provided at an outer surface of the housing abutting the first surface 140. In some other embodiments, the illuminator 240 may be integrated with an electronic circuit board (for example, electronic circuit board of the controller 220), and the housing 105 has necessary features to facilitate light emission from the illuminator 240 to pass through the channel 160. For example, the housing 105 may have a hole that facilitates light emission from the illuminator 240 into the channel 160. The housing 105 may be mounted on the first surface 140 such that the hole coincides with the channel 160.

In some embodiments, the illuminator 240 may be LED indicator. In some other embodiments, the illuminator 240 may be in the form of a halo surrounding an opening of the channel 160 at the first surface 140. The illuminator 240 can be provided at another opening of the channel 160 at the second surface 150. In this case, a connection of the illuminator 240 may pass from the housing 105 to the illuminator 240 at the second surface 150 through the channel 160. In some embodiments, the illuminator 240 may be provided on the housing 105 of the sensing unit 100.

In some embodiments, the controller 220 is in communication with the illuminator 240 to operate the illuminator 240 corresponding to the differential pressure value. For example, the controller 220 may operate the illuminator 240 with red color light if the differential pressure value is not within prescribed limit, and operate the illuminator 240 with green color light if the differential pressure value is within prescribed limit.

The sensing unit 100 may include a door position sensor 250 provided to sense position of the door 110, and transmit door position data to the controller 220. In one embodiment, the door position sensor 250 is an accelerometer, preferably a 3-axis accelerometer. In some other embodiment, the door position sensor 250 is a magnetic proximity sensor including a magnet placed on a fixed frame of the door 110. The magnetic proximity sensor senses proximity to a magnetic field generated by the magnet. When the door 110 is closed, the magnetic proximity sensor identifies intensity of the magnetic field as maximum to determine that the door 110 is closed. Similarly, when the sensor determines that the magnetic field intensity is lower than a threshold value, the sensor is away from the magnet, indicating that the door 110 is open. In some other embodiments, the door position sensor 250 may be an optical sensor, wherein the sensor emits a light beam. When the door 110 is closed, the light beam reflects off the fixed frame of the door 110, and can be detected by the sensor, which signifies that the door 110 is closed. When the door 110 is open, the light beam is not reflected, and the sensor does not receive reflected light beam. It is to be noted that the types of the door position sensor 250 discussed herein are examples only, and the present disclosure is not limited to aforementioned door position sensors. Any other sensor determining the position of the door 110 can be implemented suitably in the sensing unit 100 of the present disclosure.

In some scenarios, the door 110 may be a sliding door. In this case, the sensing unit 100 may be mounted on a frame of the door 110 that is continuously exposed to the first space 120 and the second space 130 in both open and close door conditions. The door position sensor 250 may be calibrated as per type of the door. For example, in case of sliding door, the accelerometer may be configured to detect linear motion. In case of swinging door, the accelerometer may be configured to detect swinging motion of the door.

In some other embodiments, the sensing unit 100 may be mounted on a fixed frame to which the door 110 is attached. In this case, the door position sensor 250 may be mounted on the fixed frame, and configured to determine position of the door 110. For example, the door position sensor 250 may be a Hall effect sensor or a magnetic proximity sensor that senses a magnet mounted on the door 110. When the door 110 is closed, the magnet and the door position sensor 250 are in closest proximity, thus, the door position sensor 250 determines that the door 110 is closed when the magnet or magnetic field generated by the magnet is detected.

In some other embodiments, only the door position sensor 250 may be mounted on the door 110, whereas all other components of the sensing unit 100 described herein may be mounted on the fixed frame. As such, the door position sensor 250 may communicate door position wirelessly, either with the controller 220 or with other external devices.

The sensing unit 100 is configured to wirelessly transmit the position of the door 110 detected by the door position sensor 250 to external devices, for example, a building management system. In some embodiments, the controller 220 may communicate with the door position sensor 250 to receive the door position data, and further transmit the position of the door 110 wirelessly via the communication circuitry 225 to external devices, for example, a building management system. In some other embodiments, the door position sensor 250 may be embedded with wireless communication capabilities, wherein the door position sensor 250 may wirelessly communicate the door position data to external devices, for example, a building management system.

In some embodiments, the controller 220 may mask or filter out differential pressure values when the door 110 is open. Further, the controller 220 may prevent the transmission of differential pressure data to external devices (for example, a building management system) when the door 110 is open to save battery power. Frequency of transmissions or storage can be adjusted to save battery power in some embodiments.

In some embodiments, the sensing unit 100 may include one or more sensors 260 to sense other parameters associated with the first space 120. For example, the sensors 260 may include, but not limited to, a temperature sensor, a humidity sensor, a gas concentration sensor (like carbon dioxide sensor), lighting sensor, particle sensor, etc. disposed in the housing 105 or suitably mounted on the first surface 140 of the door 110. The sensors 260 may transmit sensed data to the controller 220 may process sensed data and transmit processed data to external devices via the communication circuitry 225. The data from sensors 260 can be stored locally with differential pressure readings in some embodiments. In some other embodiments, the sensors 260 may have a wireless communication device to transmit sensed data to the external devices wirelessly without aid of the communication circuitry 225.

The sensing unit 100 may further include a user interface 270 in communication with the controller 220. The user interface 270 may include a display and/or user input module for receiving inputs from a user. The inputs may be communicated to the controller 220, wherein the controller 220 is configured to make changes in instructions stored in the memory. Further, the controller 220 is configured to display various data (for example, differential pressure value at given instance) on the user interface 270. The user interface 270 may form a front surface of the housing 105 facing the first space 120.

In some embodiments, the sensing unit 100 may be embedded in a handle of the door 110. For example, the illuminator 240 may be provided in the handle of the door 110 as a halo. In some other embodiments, the housing 105 may be formed in a shape of a handle of the door 110. In some other embodiments, the illuminator 240 may be provided around the user interface 270 forming a boarder of the user interface 270 or as a halo. The user interface 270 may be mounted on a handle or at any other suitable portion of the door 110 such that light emitted from the illuminator 240 passes through the channel 160. Details of mounting a halo (for example, the illuminator 240) onto a display device are described in U.S. patent application Ser. No. 16/246,447 titled ‘Display Device with Halo’, which is incorporated herein by reference in its entirety.

The sensing unit 100 may include a battery 280 for powering components of the sensing unit 100. In some embodiments, as shown in FIG. 2a, the battery 280 may power one or more of the pressure sensing element 212, the controller 220, the illuminator 240, the door position sensor 250, the user interface 270, and the sensors 260. In some embodiments, the battery 280 may power all components of the sensing unit 100. In some other embodiments, individual batteries may be disposed in the housing 105 for powering each component within the housing 105. In some other embodiments, the sensing unit 100 may include more than one battery, wherein each battery may power one or more components in the housing 105. In some other embodiments, the sensing unit 100 may include auxiliary batteries or provision for auxiliary batteries. The Auxiliary batteries are implemented when the primary battery (for example, the battery 280) is not in working condition. This reduces downtime of the sensing unit 100, and provides ample time to an operator to replace primary batteries.

In some embodiments, the controller 220 may be configured to operate in a power saving mode, wherein the controller 220 may cut power supply from the battery 280 to one or more components of the sensing unit 100. In certain applications, such as in patient's room, the door 110 may be kept open when the patient's room is not occupied. In such case, the energy of the battery 280 may be saved to increase overall life of the battery 280. To operate in the power saving mode, the controller 220 communicates with the door position sensor 250 to receive door position data. Further, the controller 220 may determine whether the door 110 is open for a predetermined time period. To determine this, the controller 220 may communicate with the door position sensor 250 to receive sensed data in predetermined time intervals. For example, the controller 220 may communicate with the door position sensor 250 every 5 minutes, 20 minutes, or 30 minutes. Time interval in two consecutive communications between the controller 220 and the door position sensor 250 may be determined based on use of the first space 120.

Based on received door position data related to the door 110, the controller 220 may determine if the door 110 is open for a predetermined time period. Further, the controller 220 may interrupt the battery 280 from powering one or more components of the sensing unit 100. The controller 220 may reinitiate power supply from the battery 280 once the door 110 is closed for a predetermined time period.

In some embodiments, the controller 220 may control battery power supply to the components of the sensing unit 100 based on user input received via the user interface 270.

In an operative configuration, the controller 220 communicates with the pressure sensing element 212 to receive the differential pressure value. The controller 220 further operates the illuminator 240 based on sensed differential pressure. The illuminator 240 may be operated to emit light of different color. For example, when the differential pressure is within a prescribed limit, the illuminator 240 may emit green light. When the differential pressure is not within the prescribed limit, the illuminator 240 may emit yellow or red light. The illuminator 240 may be mounted at the first surface 140, wherein the light guide conveys light emitted by the illuminator 240 up to the second surface 150 so that an observer can notice the light by the illuminator 240 through the second space 130. Further, the controller 220 may display differential pressure on the user interface 270. In some embodiments, the controller 220 may communicate with other sensors 260 of the sensing unit 100 to receive sensed data, and to display parameter values sensed by the sensors 260 on the user interface 270.

Referring to FIG. 2b, another embodiments of the sensing unit 100 is shown. In FIGS. 1-2b, common parts have been given like reference numerals, and a description thereof has been omitted unless there is a particular need. It is understood that description of common parts described in foregoing paragraphs applies to parts of FIG. 2b unless it is specifically described.

The sensing unit 100 may include a pressure sensor 282 having a first port 284, a second port 286, a sensing element 287, a processing circuitry 288, and a battery 289. The pressure sensor 282 may be mounted on the partition, for example, the door 110. The first port 284 and the second port 286 may be operated in a way similar to that of the first port 200 and the second port 210, respectively. For example, when the pressure sensor 282 is mounted in the first space 120, a tube may be connected to the second port 286, wherein the tube passes through the channel on the partition to access air in the second space 130. The processing circuitry 288 may include a processor, a memory, and a communication circuitry with wireless communication capabilities. The first port 284 and the second port 286 senses pressure in the first space 120 and the second space 130, respectively. The processing circuitry 288, with the help of the sensing element 287, is configured to determine differential pressure value between the first space 120 and the second space 130 based on sensed pressure values received from the first port 284 and the second port 286. Further, the pressure sensor 282 may transmit differential pressure value to the controller 220. In some embodiments, the pressure sensor 282 may transmit the differential pressure value to external devices wirelessly via the communication circuitry of the pressure sensor 282.

In some other embodiments, the illuminator 240 may be integrated with the pressure sensor 282, wherein the illuminator 240 is configured to emit light of different colors corresponding to the differential pressure determined by the pressure sensor 282. For example, the pressure sensor 282 may have a pressure status indicator that acts as the illuminator 240.

In some other embodiments, the pressure sensor 282 may have the battery 289 dedicated for the pressure sensor 282. In some other embodiments, the pressure sensor 282 may be positioned within the housing 105, wherein the pressure sensor 282 may be powered using the battery 280.

In some other embodiments, the pressure sensor 282 may be positioned out of the housing 105. For example, the pressure sensor 282 may be mounted on a wall, wherein other components of the sensing unit 100 may be mounted on the door 110. The pressure sensor 282 may wirelessly transmit differential pressure value to the controller 220.

In some embodiments, the controller 220 receives door position data from the door position sensor 250, and further configured to communicate with the pressure sensor 282 to terminate pressure sensing operation when the door 110 is open. In some embodiments, the controller 220 may prevent the pressure sensor 282 from transmitting differential pressure values to external devices when the door 110 is open.

In some other aspects of the present disclosure, components of the sensing unit 100, except the door position sensor 250, may be mounted on a wall proximate to the door 110. The channel 160 may be configured in the wall. Further, the door position sensor 250 may be mounted on the door 110, and may wirelessly transmit door position data to the controller 220 mounted on the wall.

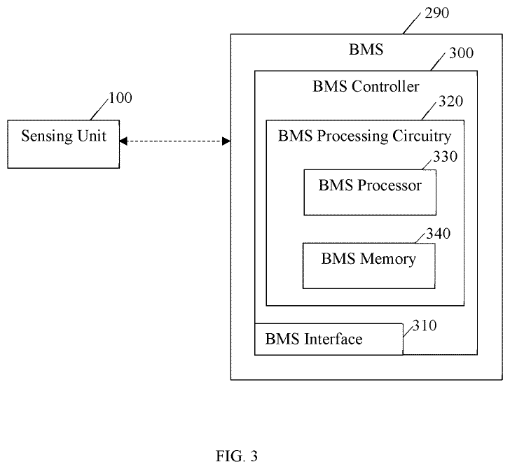

FIG. 3 is a schematic block diagram depicting communication between the sensing unit 100 and a building management system (BMS) 290. Referring to FIG. 3, the sensing unit 100 wirelessly communicates with the BMS 290. The sensing unit 100 may utilize the communication circuitry 225 to enable wireless communication. In some embodiments, the sensing unit 100 may transmit differential pressure values and door position data wirelessly to the BMS 290 in predetermined time intervals. The sensing unit 100 may transmit differential pressure values and door position data on request from the BMS 290.

The BMS 290 may include a BMS controller 300 having a BMS interface 310 to establish communication with the sensing unit 100. The BMS interface 310 may be a communications interface. For example, BMS interface 310 may include wired or wireless interfaces (e.g., jacks, antennas, transmitters, receivers, transceivers, wire terminals, etc.) for conducting data communications with various systems, devices, or networks. The BMS interface 310 can include an Ethernet card and port for sending and receiving data via an Ethernet-based communications network. In another example, The BMS interface 310 includes a Wi-Fi transceiver for communicating via a wireless communications network with other devices, for example, the sensing unit 100. The BMS interface 310 may be configured to communicate via local area networks or wide area networks (e.g., the Internet, a building WAN, etc.).

In some embodiments, BMS interface 310 includes an application gateway configured to receive input from applications running on client devices. For example, the BMS interface 310 may include one or more wireless transceivers (e.g., a Wi-Fi transceiver, a Bluetooth transceiver, an NFC transceiver, a cellular transceiver, etc.) for communicating with client devices. The BMS interface 310 can include any number of software buffers, queues, listeners, filters, translators, or other communications-supporting services.

In some embodiments, the BMS 290 includes a middleware, wherein the sensing unit 100 may transmit data wirelessly with the BMS interface 310 via the middleware. The middleware may include services that allow interoperable communication to, from, or between the BMS 290 and the sensing unit 100. The middleware may be, for example, an EnNet server sold by Johnson Controls, Inc. In some embodiments, the middleware may be provided separately. In some other embodiments, the middleware and the BMS controller may be integrated. For example, middleware may be a part of BMS controller.

The BMS controller 300 includes a BMS processing circuitry 320 having a BMS processor 330 and a BMS memory 340. The BMS processor 330 may be a general purpose or specific purpose processor, an application specific integrated circuit (ASIC), one or more field programmable gate arrays (FPGAs), a group of processing components, or other suitable processing components. The BMS processor 330 is configured to execute computer code or instructions stored in the BMS memory 340 or received from other computer readable media (e.g., CDROM, network storage, a remote server, etc.).

The BMS memory 340 may include one or more devices (e.g., memory units, memory devices, storage devices, etc.) for storing data and/or computer code for completing and/or facilitating the various processes described in the present disclosure. The BMS memory 340 may include random access memory (RAM), read-only memory (ROM), hard drive storage, temporary storage, non-volatile memory, flash memory, optical memory, or any other suitable memory for storing software objects and/or computer instructions. The BMS memory 340 may include database components, object code components, script components, or any other type of information structure for supporting the various activities and information structures described in the present disclosure. The BMS memory 340 may be communicably connected to the BMS processor 330 via the BMS processing circuitry 320 and may include computer code for executing (e.g., by the BMS processor 330) one or more processes described herein. When the BMS processor 330 executes instructions stored in the BMS memory 340 for completing the various activities described herein, the BMS processor 330 generally configures the BMS controller 300 (and more particularly BMS processing circuitry 320) to complete such activities.

The BMS controller 300 is configured to tag the sensing unit 100 with a predefined space in which the sensing unit 100 is implemented. The predefined space can be an entire building, a floor of a building, or individual rooms on each floor. The BMS controller 300 may be further configured to receive differential pressure and door position data from the sensing unit 100, preferably over a wireless network. The BMS controller 300 (and more particularly BMS processing circuitry 320) may generate a differential pressure status report having the differential pressure data for the tagged space with a timestamp. The differential pressure status report may be generated in a suitable format, for example, in a downloadable format. The differential pressure status report may include differential pressure data with a time stamp (date and time) and name of tagged space. The differential pressure status report may include a historical data of differential pressure values. The differential pressure status report can be used for data compliance activities (for example, a data compliance report) associated with regulating agencies.

In some embodiments, the controller 220 of the sensing unit 100 may receive occupancy information from the BMS 290 based on which the controller 220 may disconnect the power supply of the battery 280 to one or more components of the sensing unit 100.

In some embodiments, the BMS controller 300 may be configured to filter out differential pressure values when the door 110 is open. The BMS controller 300 may utilize door position data received from the door position sensor 250 to determine status of the door 110. The BMS controller 300 further corelates door status with received differential values, and filter out the differential values from the differential pressure status report when the door 110 is open. In some other embodiments, the BMS controller 300 may generate a sensor error report having differential pressure data when the door 110 is open. This report can be utilized to determine whether the pressure sensor/sensing element is operating correctly. For example, when the door 110 is open, the sensed differential pressure value should be zero or close to zero. The sensor error report should ideally contain differential pressure values as zero or close to zero. Other factors can also be considered along with the sensor error report to determine if the pressure sensor/sensing element is operating without any fault. Other factors may include checking whether the door position sensor 250 has any fault, or checking sensor error report generated at different time, etc.

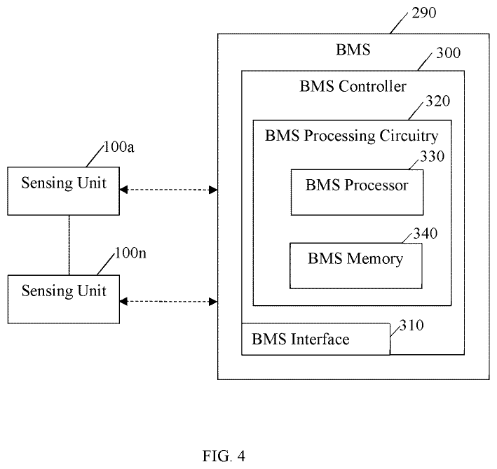

In another embodiments, as shown in FIG. 4, the BMS controller 300 is in communication with a plurality of sensing units 100a-100n disposed in different spaces in a building. The BMS controller 300 may be configured to tag each sensing unit 100a-100n to a building space in which that sensing unit is implemented. The BMS controller 300 may further receive differential pressure values and door position data from each sensing unit 100a-100n. In some embodiments, the BMS controller 300 may generate individual differential pressure status report, and optionally, sensor error report per aforementioned process for each sensing unit 100a-100n. In some other embodiments, the BMS controller 300 may generate a consolidated differential pressure status report, and optionally, sensor error report by grouping two or more sensing units 100a-100n. The BMS controller 300 may group the sensing units 100a-100n according to the spaces. For example, a group may include the sensing units implemented at one floor of the building.

The BMS controller 300 may receive sensed data form other sensors 260, and generate appropriate reports based on received data from the sensors 260.

### Configuration of Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions, and arrangement of the exemplary embodiments without departing from the scope of the present disclosure.

The present disclosure contemplates methods, systems, and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A battery powered sensing unit mounted on a partition between a first space and a second space to:
sense differential pressure between the first space and the second space;
determine a door position of a door between the first space and the second space; and
wirelessly communicate the differential pressure and the door position to a building management system.

2. The battery powered sensing unit of claim 1, further comprising an illuminator providing visual indication of differential pressure status.

3. The battery powered sensing unit of claim 2, wherein the illuminator is mounted on a first surface of the partition facing the first space, and the sensing unit includes a light guide extending between the first surface and an opposite second surface of the partition to enable visual indication of the differential pressure status.

4. The battery powered sensing unit of claim 1, further comprising one or more sensors provided to sense at least one of humidity, temperature, and gas concentration associated with the first space.

5. The battery powered sensing unit of claim 1, wherein the partition is the door between the first space and the second space.

6. The battery powered sensing unit of claim 1, wherein the partition is a wall between the first space and the second space.

7. A sensing unit for sensing between a first space and a second space, the sensing unit comprising:
a circuit configured to:
sense differential pressure between the first space and the second space;
determine a door position of a door between the first space and the second space; and
wirelessly communicate the differential pressure and the door position to a building management system.

8. The sensing unit of claim 7, further comprising an illuminator providing visual indication of differential pressure status.

9. The sensing unit of claim 8, wherein the illuminator is mounted on a first surface of a partition facing the first space, and the sensing unit includes a light guide extending between the first surface and an opposite second surface of the partition to enable visual indication of the differential pressure status.

10. The sensing unit of claim 7, further includes one or more sensors provided to sense at least one of humidity, temperature, and gas concentration associated with the first space.

11. The sensing unit of claim 9, wherein the partition is the door between the first space and the second space.

12. The sensing unit of claim 9, wherein the partition is a wall between the first space and the second space.

13. The sensing unit of claim 7, wherein the circuit is disposed on a partition between the first space and the second space.

14. A method of sensing between a first space and a second space, the method comprising:
sensing differential pressure between the first space and the second space;
determining a door position of a door between the first space and the second space; and
wirelessly communicating the differential pressure and the door position to a building management system.

15. The method of claim 14, wherein the sensing is performed by a battery powered sensor disposed on a partition between the first space and the second space.

16. The method of claim 14, further comprising providing a visual indication of differential pressure status.

17. The method of claim 15, wherein an illuminator is mounted on a first surface of the partition facing the first space, and the sensing uses a sensing unit comprising a light guide extending between the first surface and an opposite second surface of the partition to enable visual indication of the differential pressure status.

18. The method of claim 14, wherein one or more sensors provided at least one of humidity, temperature, and gas concentration associated with the first space.

19. The method of claim 15, wherein the partition is the door between the first space and the second space.

20. The method of claim 15, wherein the partition is a wall between the first space and the second space.
